(19) United States
(12) Patent Application Publication
(10) Pub. No.: US 2021/0291809 A1
(43) Pub. Date: Sep. 23, 2021

(54) INFORMATION PROCESSING APPARATUS, INFORMATION PROCESSING SYSTEM, INFORMATION PROCESSING METHOD, AND TERMINAL APPARATUS

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/201,290

(22) Filed: Mar. 15, 2021

(30) Foreign Application Priority Data
Mar. 23, 2020 (JP) 2020-051060

(51) Int. Cl. B60W 30/06; G08G 1/14; B60W 60/00; H04W 4/40

(52) U.S. Cl. CPC B60W 30/06; H04W 4/40; B60W 60/001; G08G 1/141

(57) ABSTRACT

An information processing apparatus includes a communication interface and a controller. The communication interface receives, from a first terminal apparatus of a first user who entrusts management of a vehicle ridden into a predetermined area, entrustment request information including information that specifies the predetermined area. The controller determines a second user to assume management of the vehicle based on the entrustment request information and outputs information to a second terminal apparatus of the second user.

### CROSS-REFERENCE TO RELATED APPLICATION

This application claims priority to Japanese Patent Application No. 2020-51060, filed Mar. 23, 2020, the entire contents of which are incorporated herein by reference.

### TECHNICAL FIELD

The present disclosure relates to an information processing apparatus, an information processing system, an information processing method, and a terminal apparatus.

### BACKGROUND

Parking lots with a boarding area suitable for automatic valet parking are known. For example, patent literature (PTL) 1 discloses a parking lot including a boarding area with a vehicle waiting space and a passenger space.

### CITATION LIST

### Patent Literature

PTL 1: JP 2018-145655 A

### SUMMARY

Parking lots are used when a user leaves a vehicle. Improved convenience when a user leaves a vehicle is desired.

It would be helpful to improve convenience when a user leaves a vehicle.

An information processing apparatus according to an embodiment of the present disclosure includes a communication interface configured to receive, from a first terminal apparatus of a first user who entrusts management of a vehicle ridden into a predetermined area, entrustment request information including information that specifies the predetermined area; and a controller configured to determine a second user to assume management of the vehicle based on the entrustment request information and output information to a second terminal apparatus of the second user.

An information processing system according to an embodiment of the present disclosure includes the aforementioned information processing apparatus, the aforementioned first terminal apparatus, and the aforementioned second terminal apparatus.

An information processing method according to an embodiment of the present disclosure includes receiving, by an information processing apparatus, from a first terminal apparatus of a first user who entrusts management of a vehicle ridden into a predetermined area, entrustment request information including information that specifies the predetermined area; and determining, by the information processing apparatus, a second user to assume management of the vehicle based on the entrustment request information and outputting information to a second terminal apparatus of the second user.

A terminal apparatus according to an embodiment of the present disclosure is for a user who assumes management of vehicles ridden into a predetermined area. The terminal apparatus includes a communication interface configured to transmit assumption request information including information that specifies the predetermined area and receive information on a vehicle determined based on the assumption request information; and a controller configured to output the information on the vehicle to the user.

According to the information processing apparatus, the information processing system, the information processing method, and the terminal apparatus of embodiments of the present disclosure, the convenience when a user leaves a vehicle can be improved.

### BRIEF DESCRIPTION OF THE DRAWINGS

In the accompanying drawings:

FIG. 1 is a schematic diagram illustrating a configuration of an information processing system according to an embodiment;

FIG. 2 is a block diagram illustrating a configuration of an information processing system according to an embodiment;

FIG. 3 is a diagram illustrating the transfer of vehicle management between a first user and a second user;

FIG. 4 is a flowchart illustrating an example of a procedure performed by a server to provide a management intermediary service;

FIG. 5 is a flowchart illustrating an example of a procedure, performed by a first terminal apparatus, in which the first user entrusts management of a vehicle;

FIG. 6 is a flowchart illustrating an example of a procedure, performed by a second terminal apparatus, in which the second user assumes management of the vehicle; and

FIG. 7 is a flowchart illustrating an example of a procedure performed by the server to provide an on-demand bus service.

### DETAILED DESCRIPTION

(Overview of Information Processing System 1)

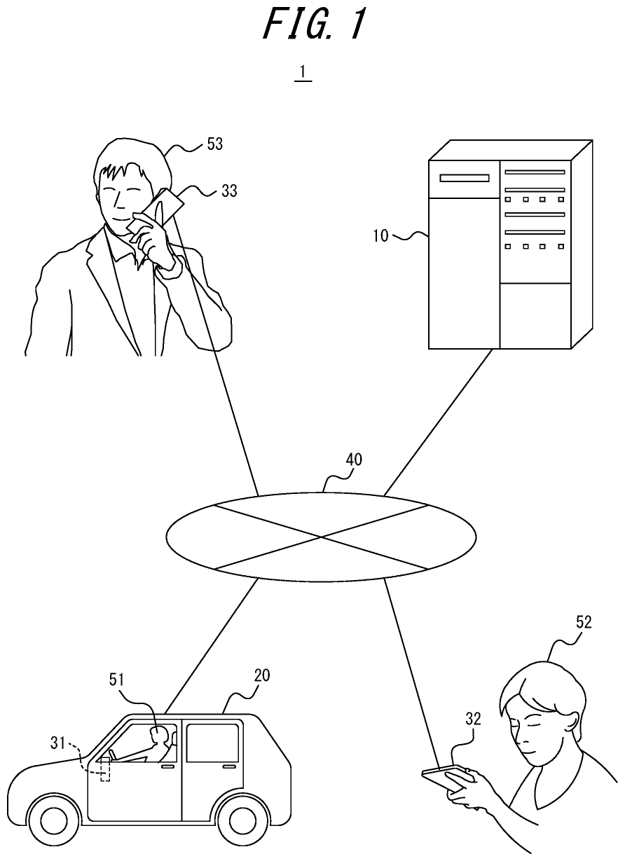

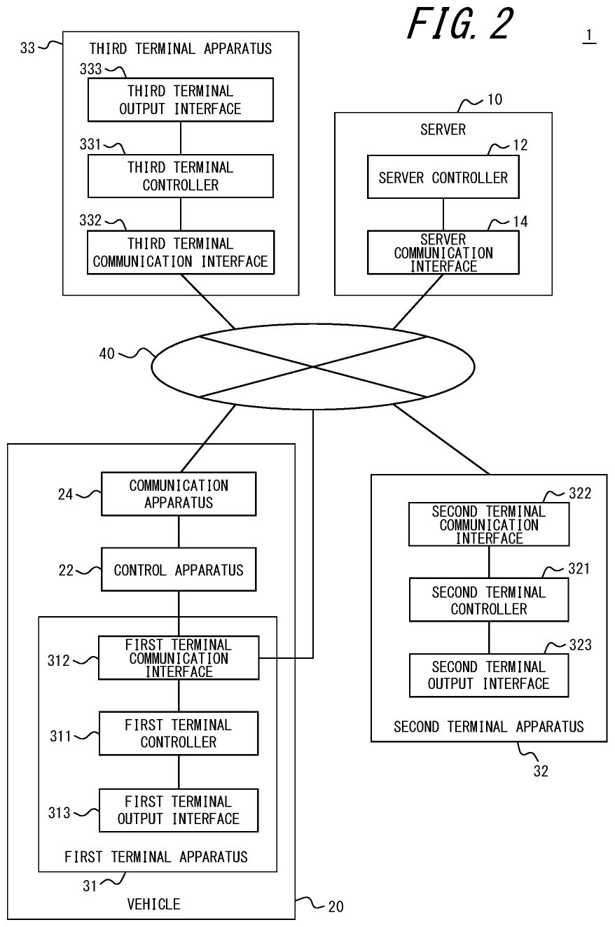

As illustrated in FIGS. 1 and 2, the information processing system 1 according to an embodiment includes a server 10 and a vehicle 20. The vehicle 20 is assumed to be operated by a first user 51. The vehicle 20 may be owned by the first user 51.

The information processing system 1 further includes a first terminal apparatus 31 and a second terminal apparatus 32. The first terminal apparatus 31 may include an apparatus mounted on the vehicle 20 or may include an apparatus owned by the first user 51. The first terminal apparatus 31 may function as car navigation for the vehicle 20. The second terminal apparatus 32 is owned by a second user 52.

The information processing system 1 may optionally further include a third terminal apparatus 33. The third terminal apparatus 33 is owned by a third user 53. The number of servers 10, vehicles 20, first terminal apparatuses 31, second terminal apparatuses 32, and third terminal apparatuses 33 is not limited to one of each, and two or more of each may be included.

The server 10, the vehicle 20, the first terminal apparatus 31, the second terminal apparatus 32, and the third terminal apparatus 33 are connected in a wired or wireless manner so as to communicate with each other over a network 40.

### Examples of Services Provided by Information Processing System 1

The information processing system 1 can provide the services illustrated below.

<Management Intermediation for Vehicle 20>

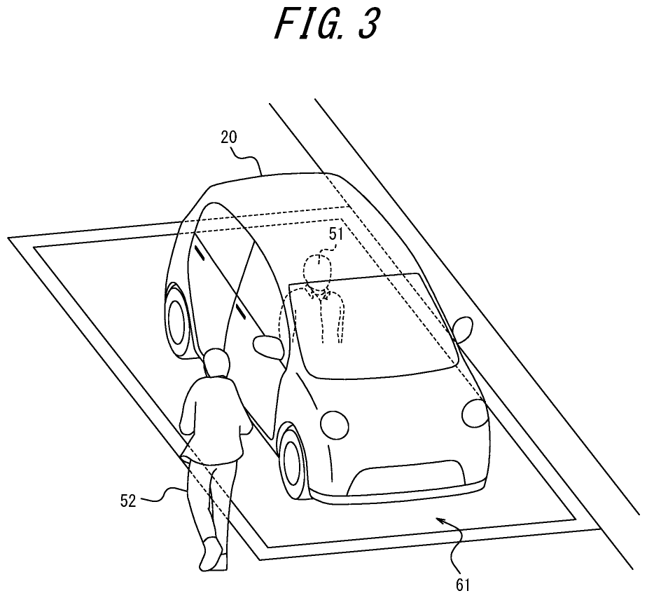

The first user 51 rides into a first area 61 in the vehicle 20, as illustrated in FIG. 3. The first area 61 includes an area in which the vehicle 20 can be stopped or parked at least temporarily. The first user 51 exits the vehicle 20 in the first area 61 and spends time in the first area 61, in the surrounding area of the first area 61, or the like. The first area 61 may, for example, be an area that includes commercial facilities, entertainment facilities, accommodation facilities, or the like. The first area 61 may be an outdoor area or an indoor area.

The vehicle 20 needs to be managed while the first user 51 is away from the vehicle 20. The vehicle 20 may be managed by being parked in a parking lot or the like, but in the present embodiment, it is assumed that the vehicle 20 is managed by an administrator other than the first user 51. The first user 51 turns over the vehicle 20 to the second user 52 when exiting the vehicle 20 for the second user 52 to manage the vehicle 20 as the administrator of the vehicle 20. In other words, the second user 52 takes over the management of the vehicle 20 from the first user 51 as the administrator of the vehicle 20 when the first user 51 exits the vehicle 20. The second user 52 may move the vehicle 20 from the first area 61 to another location while managing the vehicle 20. As described below, the second user 52 may operate the vehicle 20 as an on-demand bus and allow a third user 53 to board.

The first user 51 receives the vehicle 20 from the second user 52 at a predetermined time boards the vehicle 20, and departs. In other words, the first user 51 takes over the management of the vehicle 20 from the second user 52 when receiving the vehicle 20 from the second user 52 and boarding the vehicle 20. The first user 51 may receive the vehicle 20 from the second user 52 in the first area 61. In this case, the second user 52 moves the vehicle 20 to the first area 61 by a predetermined time for turning over the vehicle 20 to the first user 51. The first user 51 may receive the vehicle 20 from the second user 52 in a second area different from the first area 61. In this case, the second user 52 moves the vehicle 20 to the second area by the predetermined time for turning over the vehicle 20 to the first user 51.

The first area 61 into which the first user 51 rides in the vehicle 20 to hand management over to the second user 52, and the first area 61 or the second area where the first user 51 receives the vehicle 20 from the second user 52, are also referred to as a predetermined area.

The period during which the first user 51 entrusts the second user 52 with management of the vehicle 20 is also referred to as the first period. The first period corresponds to a period from the time when the first user 51 turns over the vehicle 20 to the second user 52 to the time when the first user 51 receives the vehicle 20 from the second user 52. The second user 52 manages the vehicle 20 during the first period. The second user 52 can use the vehicle 20 throughout the first period in which the second user is managing the vehicle 20.

The information processing system 1 intermediates between the first user 51 and the second user 52 so that when the first user 51 rides into the first area 61 in the vehicle 20, the second user 52 can be entrusted with management of the vehicle 20. The information processing system 1 may determine the second user 52 to be entrusted with management of the vehicle 20 before the first user 51 rides into the first area 61 in the vehicle 20. The information processing system 1 may determine the second user 52 to be entrusted with management of the vehicle 20 after the first user 51 rides into the first area 61 in the vehicle 20. When the second user 52 assumes management, the second user 52 receives the vehicle 20 that was ridden into the first area 61 from the first user 51 and manages the vehicle 20 throughout the first period.

The information processing system 1 transmits information on the first user 51 wishing to entrust management of the vehicle 20, or information on the vehicle 20, to the second terminal apparatus 32 of the second user 52 wishing to assume management of the vehicle 20. This makes it easier for the second user 52 to determine the vehicle 20 of which the second user 52 assumes management.

The information processing system 1 transmits information on the second user 52 wishing to assume management of the vehicle 20 to the first terminal apparatus 31 of the first user 51 wishing to entrust management of the vehicle 20. This makes it easier for the first user 51 to determine the second user 52 to whom the first user 51 entrusts management of the vehicle 20.

The information processing system 1 according to the present embodiment can provide information required for the first user 51 to entrust management of the vehicle 20 and information required for the second user 52 to assume management of the vehicle 20. The information processing system 1 may output information, to the first user 51, introducing the second user 52 with whom to entrust the management of the vehicle 20. The first user 51 may determine the second user 52 with whom to entrust management of the vehicle 20 based on the information on the second user 52. The information processing system 1 may output information, to the second user 52, on the vehicle 20 of which management is to be assumed. Based on the information on the vehicle 20, the second user 52 may determine the vehicle 20 of which management is to be assumed.

The information processing system 1 acquires information indicating that the first user 51 has determined the second user 52 as the one to whom management of the vehicle 20 is to be entrusted. The information processing system 1 acquires information indicating that the second user 52 has determined the vehicle 20 of the first user 51 as the vehicle 20 of which management is to be assumed. When the information that the first user 51 has determined to entrust the second user 52 with management and the information that the second user 52 has determined to assume management of the vehicle 20 of the first user 51 are acquired, the information processing system 1 establishes a contract for entrustment of management between the first user 51 and the second user 52. The information processing system 1 may establish a contract for entrustment of management without acquiring the information that the first user 51 has determined the user to be entrusted. The information processing system 1 may establish a contract for entrustment of management without acquiring the information that the second user 52 has determined the vehicle 20 of which the second user 52 assumes management. The information processing system 1 may establish a contract for entrustment of management despite acquiring neither the information that the first user 51 has determined the user to be entrusted nor the information that the second user 52 has determined the vehicle 20 of which the second user 52 assumes management.

The information processing system 1 can introduce the first user 51 and the second user 52 to each other with regard to the contract for management of the vehicle 20. In other words, the information processing system 1 can intermediate between the first user 51 and the second user 52 with respect to the contract for management of the vehicle 20. The service in which the information processing system 1 intermediates between the first user 51, who entrusts management of the vehicle 20, and the second user 52, who assumes management of the vehicle 20, is also referred to as a management intermediary service.

<On-Demand Bus Operation of Vehicle 20>

The second user 52 may allow passengers to board the vehicle 20 and may drive the vehicle 20 while managing the vehicle 20 during the first period. The third user 53 may determine a boardable vehicle 20, and may then board the vehicle 20, based on conditions including a boarding location or a drop-off location, a boarding time or drop-off time, or the like.

When the second user 52 acquires information on the third user 53 who wishes to board the vehicle 20 as a passenger, the second user 52 who wishes to drive the vehicle 20 after a passenger boards can easily determine the third user 53 to be a passenger who boards the vehicle 20. On the other hand, when the third user 53 acquires the information on the vehicle 20 onto which the second user 52 wishes a passenger to board, the third user 53 can easily determine the vehicle 20 to board.

The information processing system 1 according to the present embodiment can provide the information required for boarding passengers onto the vehicle 20 and operating the vehicle 20 to the second user 52 and can provide the information required for boarding the vehicle 20 as a passenger to the third user 53. The information processing system 1 may output, to the second user 52, information introducing the third user 53 wishing to board the vehicle 20 as a passenger. The second user 52 may determine the third user 53 to board the vehicle 20 as a passenger based on the information on the third user 53. The information processing system 1 may output information on the vehicle 20 that can be boarded under conditions desired by the third user 53 to the third user 53. The third user 53 may determine the vehicle 20 to board as a passenger based on the information on the vehicle 20 that can be boarded.

The information processing system 1 acquires information indicating that the second user 52 has determined the third user 53 as a passenger to board the vehicle 20. The information processing system 1 acquires information indicating that the third user 53 has determined the vehicle 20 of the second user 52 as the vehicle 20 to board. When the information that the second user 52 has determined to allow the third user 53 to board and the information that the third user 53 has determined to board the vehicle 20 of the second user 52 are acquired, the information processing system 1 establishes a contract for boarding between the second user 52 and the third user 53. The information processing system 1 may establish a contract for boarding without acquiring the information that the second user 52 has determined a passenger. The information processing system 1 may establish a contract for boarding without acquiring the information that the third user 53 has determined the vehicle 20 to board. The information processing system 1 may establish a contract for management despite acquiring neither the information that the second user 52 has determined a passenger nor the information that the third user 53 has determined the vehicle 20 to board.

The information processing system 1 can introduce the second user 52 and the third user 53 to each other with respect to boarding the vehicle 20. In other words, the information processing system 1 can intermediate between the second user 52 and the third user 53 with respect to boarding the vehicle 20. The service in which the second user 52 operates the vehicle 20 in accordance with the desire of the third user 53 is also referred to as an on-demand bus service. The information processing system 1 can support the operation of the on-demand bus service.

### Specific Examples of Each Component of Information Processing System 1

### <Server 10>

The server 10 may include a single server apparatus, or multiple server apparatuses capable of communicating with each other. The server 10 is also referred to as an information processing apparatus. The server 10 may be operated, for example, by an entity providing the management intermediary service. The server 10 may be operated, for example, by an entity providing the on-demand bus service. The server 10 may provide a plurality of services together. A server 10 may be allocated for each provided service.

When providing the management intermediary service, the server 10 acquires information from the first terminal apparatus 31 indicating that the first user 51 requests management of the vehicle 20, and acquires information from the second terminal apparatus 32 indicating that the second user 52 will take over the vehicle 20. Based on the acquired information, the server 10 may notify the first user 51 of information related to the second user 52 who can assume management of the vehicle 20. Based on the acquired information, the server 10 may notify the second user 52 of information related to the first user 51 that wishes to entrust the management of the vehicle 20. The server 10 may transmit and receive various information related to the management intermediary service to and from the first terminal apparatus 31 and the second terminal apparatus 32. In addition to these processes, the server 10 may be capable of executing various processes related to the management intermediary service.

When providing the on-demand bus service, the server 10 acquires information from the third terminal apparatus 33 indicating that the third user 53 wishes to board the vehicle 20. The server 10 determines an operation schedule of the vehicle 20. The server 10 may determine whether to allow the third user 53 to board the vehicle 20 based on the information acquired from the third terminal apparatus 33 and the operation schedule of the vehicle 20 and may notify the third terminal apparatus 33 of the determination. The server 10 may transmit and receive various types of information related to the on-demand bus service to and from the first terminal apparatus 31 mounted in the vehicle 20, the second terminal apparatus 32 carried by the second user 52, and the third terminal apparatus 33. In addition to these processes, the server 10 may be capable of executing various processes related to the on-demand bus service.

The server 10 includes a server controller 12 and a server communication interface 14. The server controller 12 is also referred to simply as a controller. The server controller 12 may include at least one processor. The “processor” is a general-purpose processor, a dedicated processor specialized for specific processing, or the like in the present embodiment but is not limited to these. The server controller 12 may include at least one dedicated circuit. The dedicated circuit may include, for example, a field-programmable gate array (FPGA) or an application specific integrated circuit (ASIC). The server controller 12 may include a dedicated circuit instead of a processor, or may include a dedicated circuit along with a processor.

The communication interface 14 is also referred to simply as a communication interface. The server communication interface 14 includes a communication module and may communicate with the vehicle 20, the first terminal apparatus 31, the second terminal apparatus 32, or the third terminal apparatus 33 over the network 40. The communication module may include, but is not limited to, a communication module compliant with a mobile communication standard such as the 4th Generation (4G) or the 5th Generation (5G) standards.

The server 10 may further include a memory. The memory is a semiconductor memory, a magnetic memory, an optical memory, or the like, for example, but is not limited to these. The memory may function, for example, as a main memory, an auxiliary memory, or a cache memory. The memory may include an electromagnetic storage medium such as a magnetic disc. The memory may include a non-transitory computer-readable medium. The memory may store any information used for operation of the server 10. For example, the memory may store a system program, an application program, or the like. The server 10 may store a program, information, or the like, using a DB 15 as a memory. The memory may be included in the server controller 12.

<Vehicle 20>

The vehicle 20 includes a first terminal apparatus 31. The first terminal apparatus 31 is described below. The vehicle 20 may optionally further include a control apparatus 22 and a communication apparatus 24. The control apparatus 22, the communication apparatus 24, and the first terminal apparatus 31 are connected so as to communicate with each other via an in-vehicle network, such as a Controller Area Network (CAN), or dedicated lines.

The control apparatus 22 controls each component included in the vehicle 20. The control apparatus 22 may include at least one processor. The control apparatus 22 may include at least one dedicated circuit instead of the processor, or may include at least one dedicated circuit along with the processor. The control apparatus 22 may further include a memory.

The communication apparatus 24 communicates with the server 10 or the second terminal apparatus 32 over the network 40. The communication apparatus 24 may, for example, be a vehicle-mounted communication device. The communication apparatus 24 may include a communication module to connect with the network 40.

The vehicle 20 may be locked or unlocked by a physical key. A power source, such as an engine or motor, of the vehicle 20 may be activated by the physical key.

The vehicle 20 may control the lock or activate a power source such as an engine or motor by way of a virtual key based on radio waves, i.e. a smart Key® (smart key is a registered trademark in Japan, other countries, or both). The control apparatus 22 may control locking of the vehicle 20. The control apparatus 22 may have a function of receiving radio waves outputted by a virtual key. The control apparatus 22 may control locking of the vehicle 20 by, for example, receiving radio waves outputted by a virtual key held by the first user 51. The control apparatus 22 may control locking of the vehicle 20 by, for example, considering the second terminal apparatus 32 held by the second user 52 to be a virtual key and receiving radio waves outputted by the second terminal apparatus 32. The control apparatus 22 may permit activation of a power source, such as an engine or a motor, by receiving radio waves outputted by the virtual key.

<Terminal Apparatus>

The first terminal apparatus 31 may be mounted on the vehicle 20 by being attached to the dashboard, console, or the like of the vehicle 20. The first terminal apparatus 31 may be a car navigation device that provides a navigation function of the vehicle 20. When the first terminal apparatus 31 is carried by the first user 51, the first terminal apparatus 31 may be a portable terminal, such as a smartphone or tablet. The first terminal apparatus 31 that is a portable terminal may execute an application that provides a navigation function of the vehicle 20. The first terminal apparatus 31 that is a portable terminal may be attached to the dashboard, console, or the like of the vehicle 20 or may be carried by the first user 51.

The second terminal apparatus 32 or the third terminal apparatus 33 may be a portable terminal, such as a smartphone or tablet.

The first terminal apparatus 31, the second terminal apparatus 32, and/or the third terminal apparatus 33 communicates with the server 10 over the network 40. The first terminal apparatus 31, the second terminal apparatus 32, and/or the third terminal apparatus 33 may communicate with each other over the network 40.

The first terminal apparatus 31, the second terminal apparatus 32, and the third terminal apparatus 33 are collectively referred to as the terminal apparatus when no distinction therebetween need be made.

The first terminal apparatus 31, the second terminal apparatus 32, and the third terminal apparatus 33 respectively include a first terminal controller 311, a second terminal controller 321, and a third terminal controller 331. The first terminal controller 311, the second terminal controller 321, and the third terminal controller 331 may include one or more processors.

The terminal apparatus may include a memory. The memory may be included in each terminal controller or may be configured separately from each terminal controller. The memory is a semiconductor memory, a magnetic memory, an optical memory, or the like, for example, but is not limited to these. The memory may function, for example, as a main memory, an auxiliary memory, or a cache memory. The memory may include an electromagnetic storage medium such as a magnetic disc. The memory may include a non-transitory computer-readable medium. The memory may store any information used for operation of the server 10.

The first terminal apparatus 31, the second terminal apparatus 32, and the third terminal apparatus 33 respectively include a first terminal communication interface 312, a second terminal communication interface 322, and a third terminal communication interface 332. The first terminal communication interface 312, the second terminal communication interface 322, and the third terminal communication interface 332 may include a communication module that connects to the network 40. The second terminal communication interface 322 may transmit radio waves corresponding to a virtual key so that the second terminal apparatus 32 can function as a virtual key for the vehicle 20.

The first terminal apparatus 31, the second terminal apparatus 32, and the third terminal apparatus 33 respectively include a first terminal output interface 313, a second terminal output interface 323, and a third terminal output interface 333. The first terminal output interface 313, the second terminal output interface 323, and the third terminal output interface 333 may include a display device. The display device may include a light emitting device such as a light emitting diode (LED). The display device may include, for example, a liquid crystal display (LCD), an organic electro-luminescent (EL) display, or an inorganic EL display. The display device may include a plasma display panel (PDP). The display device is not limited to these displays and may include various other types of displays. The first terminal output interface 313, the second terminal output interface 323, and the third terminal output interface 333 may include an audio output device such as a speaker.

The terminal apparatus may include an input device. The input device may, for example, include a keyboard or a physical key, a touch panel, a touch sensor, or a pointing device such as a mouse. The input device may be configured integrally with the display device when the input device is a touch panel or a touch sensor. The input device may include, for example, a microphone or the like that accepts audio input. The terminal apparatus is not limited to these examples and may include a variety of other devices as the input device.

The terminal apparatus may include a device that acquires positional information. The terminal apparatus may include a receiver compliant with a satellite positioning system as a device for acquiring the positional information. The receiver compliant with the satellite positioning system may include, for example, a Global Positioning System (GPS) receiver.

### Specific Examples of Services Provided by Information Processing System 1

Specific examples of services provided by the information processing system 1 are described below.

<Management Intermediary Service>

The first terminal controller 311 of the first terminal apparatus 31 and the second terminal controller 321 of the second terminal apparatus 32 may run an application used to pair the first user 51 and the second user 52 with regard to entrustment and assumption of management of the vehicle 20. The first terminal communication interface 312 of the first terminal apparatus 31 transmits, to the server 10, information on a first area 61 into which the first user 51 will ride with the vehicle 20 and information specifying the first period during which the first user 51 will leave the vehicle 20. The second terminal communication interface 322 of the second terminal apparatus 32 transmits, to the server 10, information that specifies a period during which the second user 52 can manage the vehicle 20 and a location at which the second user 52 can take over the vehicle 20.

In the example of operations described below, the server 10 pairs the first user 51 and the second user 52 based on information received from the first terminal apparatus 31 and the second terminal apparatus 32.

The server communication interface 14 of the server 10 receives information, from the first terminal apparatus 31, that the first user 51 requests entrustment of management of the vehicle 20. The information that the first user 51 requests entrustment of management of the vehicle 20 is also referred to as entrustment request information. The entrustment request information includes information specifying the first area 61 into which the first user 51 will ride in the vehicle 20. The entrustment request information may further include information specifying a first period during which the first user 51 will entrust management of the vehicle 20.

The server communication interface 14 receives information, from the second terminal apparatus 32, that the second user 52 requests to assume management of the vehicle 20. The information that the second user 52 requests to assume management of the vehicle 20 is also referred to as the assumption request information. The assumption request information includes information specifying an area in which the second user 52 can assume management of the vehicle 20. The assumption request information may include information specifying a period during which the second user 52 can assume management of the vehicle 20.

The server controller 12 of the server 10 pairs the first user 51 that entrusts management of the vehicle 20 with the second user 52 that assumes management of the vehicle 20 based on the entrustment request information and the assumption request information, thereby establishing a contract for entrustment and assumption of management. A specific method by which the server controller 12 pairs the first user 51 and the second user 52 is described below.

<<Case of Second User 52 Selecting Vehicle 20>>

The server controller 12 may present the vehicle 20, for which entrustment of management has been requested, to the second user 52 as a candidate for assumption of management by the second user 52 and may prompt the second user 52 to select from among candidates. Candidates for which the second user 52 can assume management are also referred to as assumption candidates.

For example, the server controller 12 judges whether the area specified by the assumption request information received from the second terminal apparatus 32 of the second user 52 includes at least a portion of the first area 61 specified by the entrustment request information received from the first terminal apparatus 31. The area specified in the assumption request information is also referred to as the assumption request area. The server controller 12 identifies the first terminal apparatus 31 that transmitted the entrustment request information specifying the first area 61 when it is judged that the assumption request area includes at least a portion of the first area 61. The server controller 12 extracts the vehicle 20 in which the identified first terminal apparatus 31 is mounted, or the vehicle 20 of the first user 51 who carries the identified first terminal apparatus 31, as an assumption candidate and transmits information on the vehicle 20 that is the assumption candidate to the second terminal apparatus 32.

The second terminal apparatus 32 causes the second terminal output interface 323 to display or output the vehicle 20 that is the assumption candidate to prompt the second user 52 to select the vehicle 20. The second terminal apparatus 32 receives input of the selection by the second user 52 and transmits the information, from the second terminal communication interface 322 to the server 10, of the vehicle 20 selected by the second user 52. The vehicle 20 selected by the second user 52 is also referred to as the selected vehicle.

The server 10 transmits information, to provide notification that the second user 52 assumes management, to the first terminal apparatus 31 mounted in the selected vehicle or to the first terminal apparatus 31 carried by the first user 51 who drives the selected vehicle. The information providing notification that the second user 52 assumes management is also referred to as assumption information.

The first terminal apparatus 31 notifies the first user 51 by causing the first terminal output interface 313 to display or output the assumption information acquired from the server 10. The first user 51 may determine whether to entrust the management of the vehicle 20 to the second user 52. The first terminal apparatus 31 may receive input, from the first user 51, that determines whether to entrust management of the vehicle 20 to the second user 52 and may transmit the inputted information from the first terminal communication interface 312 to the server 10.

When the first user 51 determines to entrust management of the vehicle 20 to the second user 52, the server 10 may transmit information indicating that the second user 52 assumes management of the selected vehicle to the second terminal apparatus 32. In this case, the server 10 establishes a contract for entrustment of management of the vehicle 20.

When the first user 51 determines not to entrust management of the vehicle 20 to the second user 52, the server 10 may transmit information, to the second terminal apparatus 32, indicating that management of the selected vehicle cannot be assumed. In this case, the second terminal apparatus 32 may prompt the second user 52 to select another the vehicle 20 from the remaining assumption candidates. The server 10 may transmit a new assumption candidate to the second terminal apparatus 32.

The server 10 may entrust management of the vehicle 20 selected by the first user 51 without first having the first user 51 confirm whether to entrust management. This simplifies the establishment of an entrustment contract.

<<Case of First User 51 Selecting the User to be Entrusted>>

The server controller 12 may present the second user 52, who has requested to assume management, to the first user 51 as a candidate to whom the first user 51 can entrust management of the vehicle 20 and may prompt the first user 51 to select from among candidates. The candidates to whom the first user 51 can entrust management of the vehicle 20 are also referred to as entrustment candidates.

For example, the server controller 12 judges whether at least a portion of the first area 61 specified by the entrustment request information received from the first terminal apparatus 31 of the first user 51 is included in the assumption request area received from the second terminal apparatus 32. When it is judged that at least a portion of the first area 61 is included in the assumption request area, the server controller 12 identifies the second terminal apparatus 32 that transmitted the assumption request area. The server controller 12 extracts the second user 52 carrying the identified second terminal apparatus 32 as an entrustment candidate and transmits the information on the second user 52 that is the entrustment candidate to the first terminal apparatus 31.

The first terminal apparatus 31 causes the first terminal output interface 313 to display or output the second user 52, who is the entrustment candidate, and prompts the first user 51 to make a selection. The first terminal apparatus 31 receives the input of the selection by the first user 51 and transmits the information, from the first terminal communication interface 312 to the server 10, of the second user 52 selected by the first user 51. The second user 52 selected by the first user 51 is also referred to as the user selected for entrustment.

The server 10 transmits information, to provide notification that the first user 51 entrusts management of the vehicle 20, to the second terminal apparatus 32 carried by the second user 52 selected as the user for entrustment by the first user 51. The information providing notification that the first user 51 entrusts management of the vehicle 20 is also referred to as entrustment information.

The second terminal apparatus 32 notifies the second user 52 by causing the second terminal output interface 323 to display or output the entrustment information acquired from the server 10. The second user 52 may determine whether to assume management of the vehicle 20 of the first user 51. The second terminal apparatus 32 may receive input, from the second user 52, that determines whether to assume management of the vehicle 20 of the first user 51 and transmit the inputted information from the second terminal communication interface 322 to the server 10.

When the second user 52 determines to assume management of the vehicle 20 of the first user 51, the server 10 may transmit information, to the first terminal apparatus 31, indicating the determination to entrust management of the vehicle 20 to the second user 52. In this case, the server 10 establishes a contract for entrustment of management of the vehicle 20.

When the second user 52 determines not to assume management of the vehicle 20 of the first user 51, the server 10 may transmit information, to the first terminal apparatus 31, indicating that management of the vehicle 20 cannot be entrusted to the second user 52. In this case, the first terminal apparatus 31 may prompt the first user 51 to select another second user 52 from the remaining entrustment candidates. The server 10 may transmit a new entrustment candidate to the first terminal apparatus 31.

The server 10 may cause the second user 52 to assume management of the vehicle 20 without first having the second user 52 confirm whether to assume management. This simplifies the establishment of an entrustment contract.

<<Case of Server 10 Pairing First User 51 and Second User 52>>

The server 10 may generate information indicating a pairing of the first user 51 and the second user 52 based on the information acquired from the first terminal apparatus 31 and the second terminal apparatus 32 and transmit the generated information to the first terminal apparatus 31 and the second terminal apparatus 32.

The server 10 may transmit the information on the second user 52 who is a candidate to be entrusted with the management of the vehicle 20 of the first user 51 to the first terminal apparatus 31. The first terminal apparatus 31 may notify the first user 51 by causing the first terminal output interface 313 to display or output the information on the second user 52 acquired from the server 10. The first user 51 may determine whether to entrust the management of the vehicle 20 to the second user 52. The first terminal apparatus 31 may receive input from the first user 51 determining whether to entrust the management of the vehicle 20 to the second user 52 and may transmit the inputted information from the first terminal communication interface 312 to the server 10.

The server 10 may transmit information on the vehicle 20 that is a candidate for assuming management to the second terminal apparatus 32. The second terminal apparatus 32 may notify the second user 52 by causing the second terminal output interface 323 to display or output the information on the vehicle 20 acquired from the server 10. The second user 52 may determine whether to assume management of the vehicle 20 of which notification was provided. The second terminal apparatus 32 may receive input from the second user 52 regarding whether to assume management and may transmit information indicating whether to assume management to the server 10.

When the first user 51 determines to entrust the management of the vehicle 20 to the second user 52 and the second user 52 determines to assume the management of the vehicle 20, the server 10 establishes an entrustment contract for the management of the vehicle 20. When at least one of the first user 51 and the second user 52 determines not to entrust or assume management, the server 10 may generate new information pairing a first user 51 and a second user 52 and transmit the information to the first terminal apparatus 31 and the second terminal apparatus 32.

### BRIEF SUMMARY

As described above, the information processing system 1 can pair the first user 51 and the second user 52 so that a contract for entrustment of management of the vehicle 20 can be established.

To entrust the management of the vehicle 20, the first user 51 pays a usage fee for entrustment. The second user 52 receives remuneration for assuming management. The remuneration for assuming management is also referred to as an assumption remuneration. In other words, the operator of the management intermediary service collects the usage fee from the first user 51 and grants the assumption remuneration to the second user 52. The operator of the management intermediary service may determine, with the server 10, the amounts of the usage fee and the assumption remuneration. Specific examples of the server 10 determining the amounts are described below.

<On-Demand Bus Service>

In the first period during which the second user 52 manages the vehicle 20, the vehicle 20 may be operated as an on-demand bus. In the on-demand bus service, the vehicle 20 of the first user 51 is used for transporting passengers. In the on-demand bus service, not only the vehicle 20 but also other vehicles may be used for transporting passengers. The vehicle 20 of the first user 51 and the other vehicles used for transporting passengers in the on-demand bus service are also collectively referred to as operation vehicles.

<<Management of Operation Schedule>>

The information processing system 1 manages the operation schedule of the operation vehicle. The operation schedule includes the route traveled by the operation vehicle and the time at which points located along the route are passed. An example of operations for managing the operation schedule is described below.

The third terminal controller 331 of the third terminal apparatus 33 may execute an application that enables the third user 53 to request to board the on-demand bus and provides notification of the operation schedule of an operation vehicle that the third user 53 can board. The second terminal controller 321 of the second terminal apparatus 32 may execute an application for notifying the second user 52 of the operation schedule when the vehicle 20 managed by the second user 52 is used as the operation vehicle. When the first terminal apparatus 31 is mounted in the vehicle 20, the first terminal controller 311 of the first terminal apparatus 31 may execute an application for notifying the second user 52 of the operation schedule.

Specifically, the third terminal controller 331 receives input of information required to request boarding when the third user 53 wishes to board the operation vehicle. The information required to request boarding is also referred to as boarding request information. The boarding request information includes desired boarding conditions designated by the third user 53 for boarding the operation vehicle. The desired boarding conditions include a desired boarding location or departure time, a drop-off location or drop-off time, or the like desired by the third user 53. The boarding request information may include information specifying the third user 53. The boarding request information may include information required to pay the fare of the operation vehicle. The third terminal controller 331 transmits the boarding request information from the third terminal communication interface 332 to the server 10.

The server controller 12 of the server 10 extracts the operation vehicle that the third user 53 can board based on the desired boarding conditions included in the boarding request information. The operation vehicle that the third user 53 can board is also referred to as a candidate vehicle. When the server controller 12 determines that the third user 53 can board the vehicle 20 based on the desired boarding conditions of the third user 53 and the operation schedule of the operation vehicle, the vehicle 20 may be added to the candidate vehicles.

The server 10 may, for example, judge whether to add the vehicle 20 to the candidate vehicles as follows. If the vehicle 20 is to operate after allowing the third user 53 to board, the vehicle 20 at least needs to travel over a route from the first area 61 back to the first area 61 or a second area for handing over the vehicle 20 to the first user 51, while passing through the boarding location and the drop-off location. In the case of allowing the first user 51 to board, the vehicle 20 also needs to travel the route within the first period during which the second user 52 manages the vehicle 20. If the vehicle 20 can, within the first period, travel the route when the first user 51 boards, the server 10 may judge that the vehicle 20 can allow the third user 53 to board based on the desired boarding conditions of the third user 53 and may add the vehicle 20 to the candidate vehicles.

The server controller 12 transmits information on the candidate vehicles from the server communication interface 14 to the third terminal apparatus 33. The third terminal controller 331 of the third terminal apparatus 33 notifies the third user 53 by causing the third terminal output interface 333 to display or output the information on the candidate vehicle acquired from the server 10. The third user 53 selects a candidate vehicle that the third user wishes to board. The candidate vehicle that the third user 53 wishes to board is also referred to as the desired boarding vehicle. The third terminal controller 331 receives input of the desired boarding vehicle from the third user 53 and transmits information on the desired boarding vehicle from the third terminal communication interface 332 to the server 10.

When the vehicle 20 is selected as the desired boarding vehicle, the server controller 12 transmits the information on the third user 53 from the server communication interface 14 to the second terminal apparatus 32 of the second user 52 that manages the vehicle 20. The second terminal controller 321 of the second terminal apparatus 32 notifies the second user 52 by causing the second terminal output interface 323 to display or output the information on the third user 53 acquired from the server 10.

The second user 52 may select whether to accept or reject boarding of the third user 53. The second terminal controller 321 may receive input of the selection by the second user 52 and transmit information, from the second terminal communication interface 322 to the server 10, indicating whether to accept or reject boarding of the third user 53. When the second user 52 rejects boarding of the third user 53, the server controller 12 transmits information on a new candidate vehicle from the server communication interface 14 to the third terminal apparatus 33. When the second user 52 accepts boarding of the third user 53, the server controller 12 transmits information, from the server communication interface 14 to the third terminal apparatus 33, indicating that boarding on to the desired boarding vehicle has been determined.

The server controller 12 may determine that the third user 53 is to board the desired boarding vehicle without receiving the selection by the second user 52. The server controller 12 transmits information indicating that boarding of the desired boarding vehicle has been determined from the server communication interface 14 to the third terminal apparatus 33.

When it is determined that the third user 53 is to board the vehicle 20, the server controller 12 finalizes the operation schedule of the vehicle 20. The server controller 12 may change the operation schedule of the desired boarding vehicle as necessary based on the desired boarding conditions of the third user 53. The server controller 12 transmits the finalized operation schedule from the server communication interface 14 to the second terminal apparatus 32. When the first terminal apparatus 31 is mounted in the vehicle 20, the server controller 12 may transmit the finalized operation schedule from the server communication interface 14 to the first terminal apparatus 31.

When the server 10 transmits the operation schedule to the second terminal apparatus 32, the second terminal controller 321 of the second terminal apparatus 32 notifies the second user 52 of the operation schedule by causing the second terminal output interface 323 to display or output the operation schedule. When the server 10 transmits the operation schedule to the first terminal apparatus 31 mounted in the vehicle 20, the first terminal controller 311 of the first terminal apparatus 31 notifies the second user 52 of the operation schedule by causing the first terminal output interface 313 to display or output the operation schedule. The second user 52 operates the vehicle 20 based on the notified operation schedule and allows the third user 53 to board the vehicle 20. The vehicle 20 can thereby serve as an operation vehicle to transport passengers.

### BRIEF SUMMARY

As described above, the information processing system 1 can manage the operation schedule of the vehicle 20 when the vehicle 20 is used to transport passengers as an operation vehicle in an on-demand bus service.

The third user 53 pays a passenger fare for boarding the vehicle 20. The second user 52 receives remuneration for allowing the third user 53 to board. The remuneration for allowing the third user 53 to board is also referred to as an operation remuneration. In other words, the operator of the on-demand bus service collects the passenger fare from the third user 53 and grants the operation remuneration to the second user 52. The operator of the on-demand bus service may determine the amounts of the passenger fare and the operation remuneration using the server 10. Specific examples of the server 10 determining the amounts are described below.

### Specific Examples of Utilization Charges or Passenger Fares

In the information processing system 1, the usage fee and the assumption remuneration for the management intermediary service, or the amounts of the passenger fare and the operation remuneration for the on-demand bus service, are determined by the server controller 12 of the server 10. Specific examples of operations by the server controller 12 to determine the amounts are described below.

<Usage Fee and Assumption Remuneration for Management Intermediary Service>

The operator of the management intermediary service charges the first user 51 a usage fee for entrusting management of the vehicle 20. In other words, the first user 51 pays a usage fee to entrust management of the vehicle 20. On the other hand, the operator of the management intermediary service pays an assumption remuneration to the second user 52. In other words, the second user 52 receives an assumption remuneration and assumes management of the vehicle 20.

The server controller 12 may determine a usage fee to be charged to the first user 51 and an assumption remuneration to be paid to the second user 52 in accordance with the length of time during which management of the vehicle 20 is entrusted. The server controller 12 may determine the usage fee to be charged to the first user 51 and the assumption remuneration to be paid to the second user 52 to be greater amounts as the time during which management of the vehicle 20 is entrusted is longer. The server controller 12 may determine at least a portion of the usage fee to be charged to the first user 51 as the amount of the assumption remuneration to be paid to the second user 52. The operator of the management intermediary service receives the difference between the usage fee charged to the first user 51 and the assumption remuneration paid to the second user 52 as a system usage fee of the information processing system 1 for implementing the management intermediary service.

The server controller 12 may transmit information on the usage fee from the server communication interface 14 to the first terminal apparatus 31 carried by the first user 51 for the first terminal apparatus 31 to process the usage fee payment. The server controller 12 may transmit the information on the assumption remuneration from the server communication interface 14 to the second terminal apparatus 32 carried by the second user 52 for the second terminal apparatus 32 to process the granting of the assumption remuneration.

The server controller 12 may transmit information on the usage fee to be charged to the first user 51 from the server communication interface 14 to the second terminal apparatus 32. In this case, the second user 52 may receive the usage fee of which the second terminal apparatus 32 provides notification from the first user 51 when the second user 52 takes over the vehicle 20 from the first user 51 or turns the vehicle 20 over to the first user 51. The operator of the management intermediary service may collect a portion of the usage fee, received by the second user 52 from the first user 51, as a system usage fee of the information processing system 1.

<On-Demand Bus Service Passenger Fare and Operation Remuneration>

The operator of the on-demand bus service charges a fare to the third user 53 who rides in the operation vehicle. That is, the third user 53 pays the fare and uses the on-demand bus service. On the other hand, the operator of the on-demand bus service pays the operation remuneration to the second user 52. In other words, the second user 52 receives the operation remuneration and allows the third user 53 to board the vehicle 20.

The server controller 12 may calculate the passenger fare of the third user 53. The server controller 12 may calculate the passenger fare of the third user 53 based on the travel distance or the travel time of the operation vehicle from the boarding location to the drop-off location of the third user 53. The server controller 12 may determine that the passenger fare charged to the third user 53 is higher as the travel distance or the travel time of the operation vehicle is longer. The server controller 12 may determine at least a portion of the amount of the passenger fare charged to the third user 53 as the amount of the operation remuneration paid to the second user 52. The operator of the on-demand bus service receives the difference between the passenger fare charged to the third user 53 and the operation remuneration paid to the second user 52 as a system usage fee of the information processing system 1 that implements the on-demand bus service.

The server controller 12 may transmit information on the passenger fare from the server communication interface 14 to the third terminal apparatus 33 carried by the third user 53 for the third terminal apparatus 33 to process payment of the passenger fare. The server controller 12 may transmit information on the operation remuneration from the server communication interface 14 to the second terminal apparatus 32 carried by the second user 52 for the second terminal apparatus 32 to process the granting of the operation remuneration.

The server controller 12 may transmit information on the passenger fare from the server communication interface 14 to the second terminal apparatus 32. When the first terminal apparatus 31 is mounted in the vehicle 20, the server controller 12 may transmit information on the passenger fare from the server communication interface 14 to the first terminal apparatus 31. The second user 52 may receive the passenger fare, of which the first terminal apparatus 31 or the second terminal apparatus 32 provides notification, from the third user 53 when the third user 53 boards or exits. In this case, the operator of the on-demand bus service may collect a portion of the passenger fare, received by the second user 52 from the third user 53, from the second user 52 as the system usage fee of the information processing system 1.

<Distribution of Passenger Fare>

The reason why the manager of the on-demand bus service can receive the passenger fare from the third user 53 is not only because the second user 52 operates the vehicle 20, but also because the first user 51 provides the vehicle 20. Therefore, the passenger fare may be distributed not only to the second user 52 but also to the first user 51. The server controller 12 may distribute predetermined percentages of the passenger fare to the manager, the first user 51, and the second user 52.

The server controller 12 may calculate the passenger fare to be distributed to the first user 51 based on the cost of energy required to drive the vehicle 20, such as the fuel cost or the electricity cost of the vehicle 20. The server controller 12 may calculate the passenger fare to be distributed to the first user 51 based on the distance or time that the vehicle 20 traveled after the third user 53 boarded. The server controller 12 may calculate the passenger fare to be distributed to the first user 51 based on the number of third users 53 who boarded the vehicle 20. As the number of third users 53 who boarded the vehicle 20 is greater, the cost of energy needed to drive the vehicle 20 increases, and the conditions inside the vehicle 20 are more likely to be worse. The server controller 12 may increase the passenger fare to be distributed to the first user 51 as the number of third users 53 who boarded the vehicle 20 is higher.

The server controller 12 may transmit information, related to the amount to distribute to each of the first user 51 and the second user 52, from the server communication interface 14 to the first terminal apparatus 31 carried by the first user 51 and the second terminal apparatus 32 carried by the second user 52.

The server controller 12 may use the passenger fare distributed to the first user 51 to offset the usage fee of the management intermediary service to be collected from the first user 51. When the passenger fare distributed to the first user 51 is higher than the usage fee of the management intermediary service, the first user 51 receives the difference. When the passenger fare allocated to the first user 51 is lower than the usage fee of the management intermediary service, the first user 51 pays the difference. The server controller 12 may transmit information related to the difference to the first terminal apparatus 31 carried by the first user 51 for the first terminal apparatus 31 to process the granting or payment of the difference.

(Summary of Information Processing System 1)

As described above, the information processing system 1 according to the present embodiment, along with the server 10 and the terminal apparatuses, can provide a management intermediary service. In this way, when the first user 51 rides into the first area 61 with the vehicle 20, the first user 51 does not need to park the vehicle 20 in a parking space in order to leave the vehicle 20. Furthermore, the vehicle 20 is managed by the second user 52 who acts as a manager while the first user 51 is away from the vehicle 20. Consequently, the first user 51 can obtain a sense of security about the management status of the vehicle 20, and convenience for the first user 51 is improved.

The information processing system 1 according to the present embodiment, along with the server 10 and the terminal apparatuses, can also provide an on-demand bus service using the vehicle 20 for which management is entrusted. In this way, the vehicle 20 can be effectively utilized. The first user 51 therefore benefits. Increasing the number of operation vehicles in the on-demand bus service also makes it easier for the third user 53 to board an operation vehicle. Convenience is therefore improved for the third user 53.

### Example of Information Processing Method

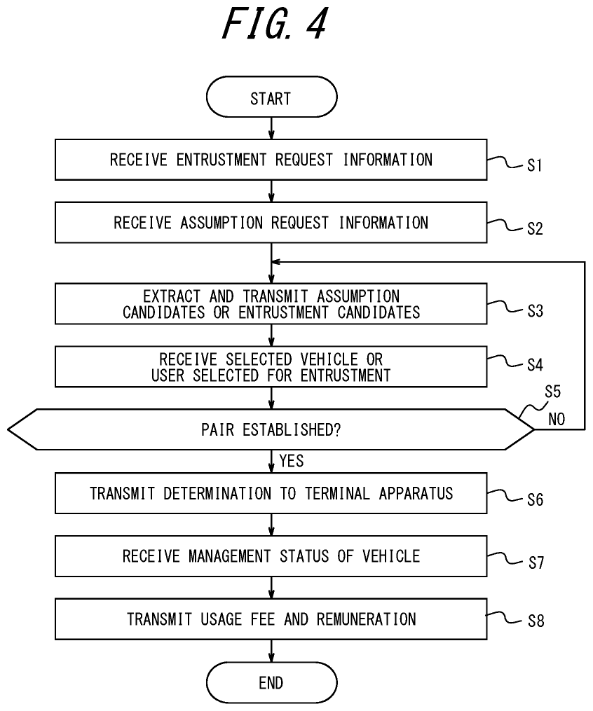

To provide the management intermediary service or the on-demand bus service, the information processing system 1 may perform an information processing method including procedures such as those in the flowcharts illustrated in FIGS. 4, 5, 6, 7, or the like. An example of the information processing method is described below.

### Example of Information Processing Method for Providing Management Intermediary Service

The information processing system 1 may perform the information processing method illustrated below to provide a management intermediary service.

### Example of Information Processing Method Performed by Server 10

To provide a management intermediary service, the server controller 12 of the server 10 may perform an information processing method that includes the procedures of the flowchart illustrated in FIG. 4. The information processing method may be implemented as an information processing program to be executed by a processor such as the server controller 12. The information processing program may be stored on a non-transitory computer-readable medium.

The server controller 12 receives the entrustment request information from the first terminal apparatus 31 (step S1). The server controller 12 receives the assumption request information from the second terminal apparatus 32 (step S2). The server controller 12 extracts the assumption candidates or the entrustment candidates based on the entrustment request information and the assumption request information and transmits the candidates to the terminal apparatus (step S3). The server controller 12 transmits the assumption candidates to the second terminal apparatus 32 and transmits the entrustment candidates to the first terminal apparatus 31.

The server controller 12 receives the selected vehicle or the user selected for entrustment (step S4). The server controller 12 receives the selected vehicle from the second terminal apparatus 32 and receives the user selected for entrustment from the first terminal apparatus 31.

The server controller 12 judges whether a pairing of the first user 51 that entrusts management of the vehicle 20 and the second user 52 that assumes management of the vehicle 20 is established (step S5). Specifically, the server controller 12 may judge that the pairing is established when the example conditions below are satisfied. For example, the server controller 12 may judge that the pairing of the first user 51 and the second user 52 is established when receiving the user selected for entrustment from the first terminal apparatus 31 and receiving the determination to assume management from the second terminal apparatus 32. The server controller 12 may judge that the pairing of the first user 51 and the second user 52 is established when the selected vehicle is received from the second terminal apparatus 32 and the determination to entrust management is received from the second terminal apparatus 32. The server controller 12 may judge that the pairing of the first user 51 and the second user 52 is established when the user selected for entrustment is received from the first terminal apparatus 31 or when the selected vehicle is received from the second terminal apparatus 32.

When the pairing of the first user 51 and the second user 52 is not established (step S5: NO), the server controller 12 returns to the procedure of step S3. When the pairing of the first user 51 and the second user 52 is established (step S5: YES), the server controller 12 transmits the determination of the user to assume management to the first terminal apparatus 31 and transmits the determination of the user to be entrusted to the second terminal apparatus 32 (step S6).

The server controller 12 receives the status of management of the vehicle 20 (step S7). Specifically, the server controller 12 receives information indicating that the second user 52 is managing the vehicle 20 in the first period or information indicating that the first user 51 has taken the vehicle 20 back from the second user 52 after the first period elapses. The server controller 12 may judge that the second user 52 is managing the vehicle 20 when acquiring, from the first terminal apparatus 31, information indicating that the first user 51 has handed over management of the vehicle 20 to the second user 52. The server controller 12 may judge that the second user 52 is managing the vehicle 20 when acquiring, from the second terminal apparatus 32, information indicating that the second user 52 has taken over management of the vehicle 20 from the first user 51. The server controller 12 may judge that the first user 51 has taken over the vehicle 20 from the second user 52 when acquiring, from the first terminal apparatus 31, information indicating that the first user 51 has taken over the vehicle 20 from the second user 52. The server controller 12 may judge that the first user 51 has taken over the vehicle 20 from the second user 52 when acquiring, from the second terminal apparatus 32, information indicating that the second user 52 has handed over the vehicle 20 to the first user 51.

The server controller 12 transmits the usage fee and the remuneration (step S8). Specifically, the server controller 12 calculates the usage fee to charge the first user 51 and transmits the usage fee to the first terminal apparatus 31. The server controller 12 also calculates the assumption remuneration to pay to the second user 52 and transmits the assumption remuneration to the second terminal apparatus 32. After confirming, by the procedure of step S7, that the entrustment and assumption of management of the vehicle 20 have been performed, the server controller 12 calculates the usage fee and the assumption remuneration. After execution of the procedure in step S8, the server controller 12 ends execution of the procedures of the flowchart in FIG. 4.

The server controller 12 may generate a pairing of the first user 51 and the second user 52 in the procedure of step S3. The server controller 12 may transmit the first user 51 in the generated pairing to the second terminal apparatus 32 as an assumption candidate and transmit the second user 52 in the generated pairing to the first terminal apparatus 31 as an entrustment candidate. In this case, the server controller 12 receives information, from the first terminal apparatus 31, that the first user 51 has determined to entrust management of the vehicle 20 to the entrustment candidate in the procedure of step S4. The server controller 12 receives information, from the second terminal apparatus 32, that the second user 52 has determined to assume management of the vehicle 20 of the assumption candidate. The server controller 12 may judge that the pairing of the first user 51 and the second user 52 is established in the procedure of step S5 when receiving the determination of entrustment or assumption of management. The server controller 12 may judge that the pairing of the first user 51 and the second user 52 is unconditionally established in the procedure of step S5 when information on the pairing of the first user 51 and the second user 52 could be generated in the procedure of step S3.

### Example of Information Processing Method Performed by First Terminal Apparatus 31

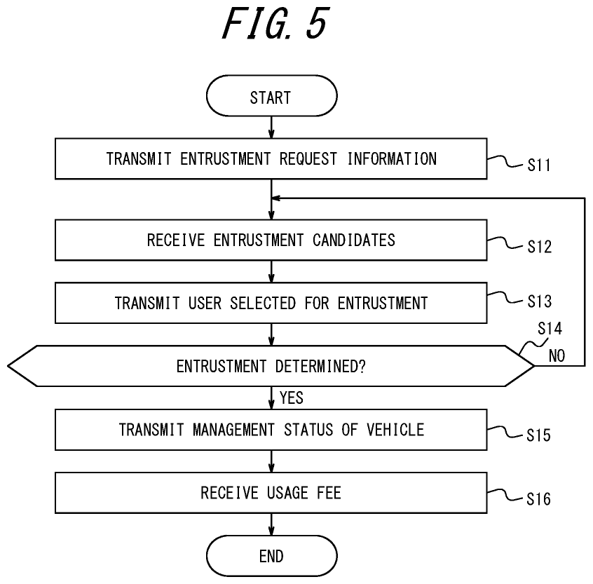

The first terminal controller 311 of the first terminal apparatus 31 may perform an information processing method including the procedures of the flowchart in FIG. 5 so that the first user 51 can use the management intermediary service. The procedures illustrated in FIG. 5 represent procedures when the first user 51 determines the user selected for entrustment from among entrustment candidates. The information processing method may be implemented as an information processing program to be executed by a processor such as the first terminal controller 311. The information processing program may be stored on a non-transitory computer-readable medium.

The first terminal controller 311 transmits the entrustment request information to the server 10 (step S11). The first terminal controller 311 receives entrustment candidates from the server 10 (step S12). The first terminal controller 311 transmits the user selected for entrustment to the server 10 (step S13).

The first terminal controller 311 judges whether a determination that the management of the vehicle 20 can be entrusted has been made (step S14). Specifically, the first terminal controller 311 judges that the determination that the management of the vehicle 20 can be entrusted has been made when acquiring information, from the server 10, indicating that the second user 52 designated as the user selected for entrustment has determined to assume management of the vehicle 20. The first terminal controller 311 judges that the determination that the management of the vehicle 20 can be entrusted has not been made when acquiring information, from the server 10, indicating that the second user 52 designated as the user selected for entrustment has determined not to assume management of the vehicle 20.

When the first terminal controller 311 has not determined that the management of the vehicle 20 can be entrusted (step S14: NO), the process returns to step S12. When the first terminal controller 311 has determined that the management of the vehicle 20 can be entrusted (step S14: YES), the first terminal controller 311 transmits the management status of the vehicle 20 to the server 10 (step S15). Specifically, when the first user 51 hands off the management of the vehicle 20 to the second user 52 or takes back the vehicle 20 from the second user 52, the first user 51 inputs the change in the status of management of the vehicle 20 to the first terminal apparatus 31. The first terminal controller 311 transmits, to the server 10, information indicating that the first user 51 has handed off the management of the vehicle 20 to the second user 52 or information indicating that the first user 51 has taken over the vehicle 20 from the second user 52.

The first terminal controller 311 receives the usage fee from the server 10 (step S16). Specifically, after completion of entrustment of management of the vehicle 20, the server 10 calculates the usage fee to be charged to the first user 51 and transmits the amount of the usage fee to the first terminal apparatus 31. The first terminal controller 311 receives the amount of the usage fee calculated by the server 10. The first terminal controller 311 may execute processing for the first user 51 to pay the received amount of the usage fee. After execution of the procedure in step S16, the first terminal controller 311 ends execution of the procedures of the flowchart in FIG. 5.

When the first terminal controller 311 judges that it has not been determined to entrust management of the vehicle 20 in the procedure of step S14, the first terminal controller 311 may return to the procedure of step S12 and receive a new entrustment candidate from the server 10. The first terminal controller 311 may return to the procedure of step S13 to determine a user selected for entrustment from among other entrustment candidates.

### Example of Information Processing Method Executed by Second Terminal Apparatus 32

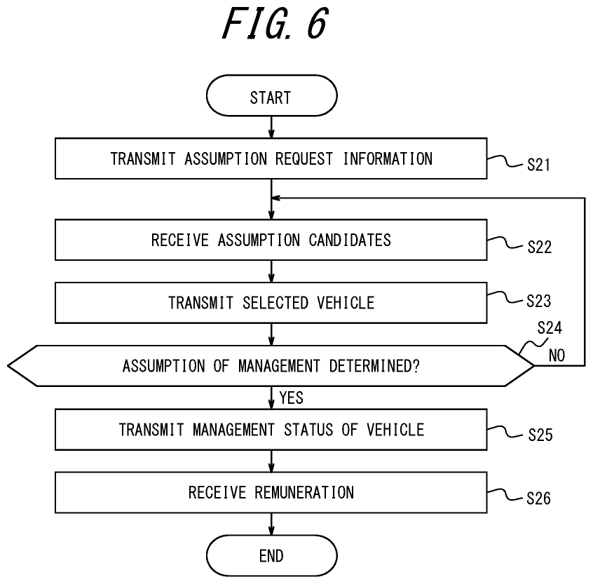

The second terminal controller 321 of the second terminal apparatus 32 may perform an information processing method including the procedures of the flowchart in FIG. 6 so that the second user 52 can use the management intermediary service. The procedures illustrated in FIG. 6 represent procedures when the second user 52 determines the selected vehicle from among the assumption candidates. The information processing method may be implemented as an information processing program to be executed by a processor such as the second terminal controller 321. The information processing program may be stored on a non-transitory computer-readable medium.

The second terminal controller 321 transmits assumption request information to the server 10 (step S21). The second terminal controller 321 receives assumption candidates from the server 10 (step S22). The second terminal controller 321 transmits the selected vehicle to the server 10 (step S23).

The second terminal controller 321 judges whether assumption of management of the vehicle 20 by the second user 52 has been determined (step S24). Specifically, when the second terminal controller 321 acquires information, from the server 10, indicating that the first user 51 has determined to entrust the management of the vehicle 20 designated as the selected vehicle, the second terminal controller 321 judges that assumption of management of the vehicle 20 by the second user 52 has been determined. When the second terminal controller 321 acquires information, from the server 10, indicating that the first user 51 has decided not to entrust the management of the vehicle 20 designated as the selected vehicle, the second terminal controller 321 judges that assumption of management of the vehicle 20 by the second user 52 has not been determined.

When assumption of management of the vehicle 20 by the second user 52 has not been determined (step S24: NO), the second terminal controller 321 returns to the procedure of step S22. When assumption of management of the vehicle 20 by the second user 52 has been determined (step S24: YES), the second terminal controller 321 transmits the management status of the vehicle 20 to the server 10 (step S25). Specifically, when the second user 52 takes over the management of the vehicle 20 from the first user 51 or hands over the vehicle 20 to the first user 51, the second user 52 inputs the change in the status of management of the vehicle 20 to the second terminal apparatus 32. The second terminal controller 321 transmits, to the server 10, information indicating that the second user 52 has taken over the management of the vehicle 20 from the first user 51 or information indicating that the second user 52 has handed over the vehicle 20 to the first user 51.

The second terminal controller 321 receives remuneration from the server 10 (step S26). Specifically, after completion of the assumption of management of the vehicle 20, the server 10 calculates the assumption remuneration to be paid to the second user 52 and transmits the assumption remuneration to the second terminal apparatus 32. The second terminal controller 321 receives the assumption remuneration calculated by the server 10. The second terminal controller 321 may execute processing for the second user 52 to accept the received assumption remuneration. After execution of the procedure of step S26, the second terminal controller 321 ends execution of the procedures of the flowchart in FIG. 6.

When the first terminal controller 311 judges that assumption of management of the vehicle 20 has not been determined in the procedure of step S24, the first terminal controller 311 may return to the procedure of step S22 and receive a new assumption candidate from the server 10. The first terminal controller 311 may return to step S23 to determine the selected vehicle from among other assumption candidates.

### Example of Information Processing Method for Providing On-Demand Bus Service

The information processing system 1 may perform the information processing method illustrated below to provide an on-demand bus service.

### Example of Information Processing Method Performed by Server 10

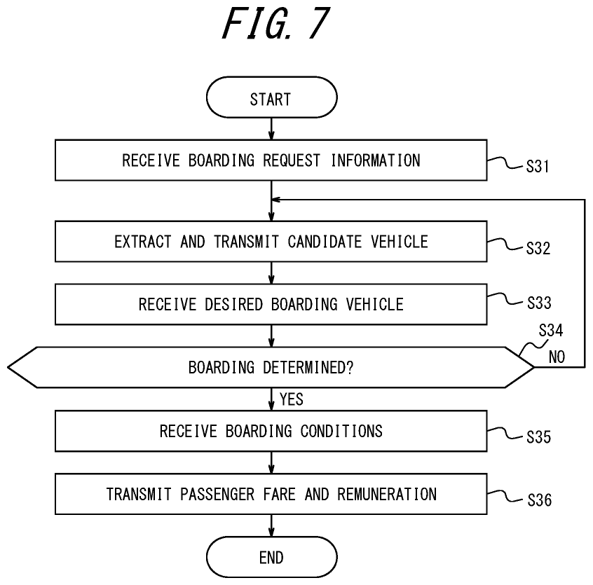

The server controller 12 of the server 10 may perform an information processing method that includes the procedures of the flowchart in FIG. 7 to provide an on-demand bus service. The information processing method may be implemented as an information processing program to be executed by a processor such as the server controller 12. The information processing program may be stored on a non-transitory computer-readable medium.

The server controller 12 receives boarding request information from the third terminal apparatus 33 (step S31). The server controller 12 extracts candidate vehicles based on the boarding request information including the desired boarding conditions of the third user 53 and transmits the candidate vehicles to the third terminal apparatus 33 (step S32). The server controller 12 receives the desired boarding vehicle from the third terminal apparatus 33 (step S33).

The server controller 12 judges whether boarding of the third user 53 on the desired boarding vehicle has been determined (step S34). Specifically, the server controller 12 may judge that boarding of the third user 53 has been determined when the example conditions below are satisfied. For example, the server controller 12 may judge that boarding of the third user 53 on the vehicle 20 designated as the desired boarding vehicle has been determined when the server controller 12 receives a determination of acceptance of boarding from the second terminal apparatus 32 of the second user 52 that manages the desired boarding vehicle. The server controller 12 may judge that boarding of the third user 53 on the vehicle 20 designated as the desired boarding vehicle has not been determined when the server controller 12 receives a determination of rejection of boarding from the second terminal apparatus 32 of the second user 52 that manages the desired boarding vehicle. When the server controller 12 receives the desired boarding vehicle by the procedure in step S33, the server controller 12 may judge that boarding of the third user 53 on the desired boarding vehicle has been determined without confirming with the second user 52.

When boarding of the third user 53 on the desired boarding vehicle is not determined (step S34: NO), the server controller 12 returns to step S32. When boarding of the third user 53 on the desired boarding vehicle is determined (step S34: YES), the server controller 12 receives boarding conditions of the vehicle 20 (step S35). Specifically, the server controller 12 receives information indicating that the third user 53 has boarded the vehicle 20 designated as the desired boarding vehicle, or information indicating that the third user 53 has exited from the vehicle 20, from the second terminal apparatus 32 or the first terminal apparatus 31 mounted in the vehicle 20. In this case, the second user 52 may provide input to the second terminal apparatus 32 or the first terminal apparatus 31 indicating that the third user 53 has boarded the vehicle 20 or that the third user 53 has exited from the vehicle 20.

The server controller 12 transmits the passenger fare and the remuneration (step S36). Specifically, the server controller 12 calculates a passenger fare to be charged to the third user 53 and an operation remuneration to be paid to the second user 52 and transmits the passenger fare and operation remuneration to the second terminal apparatus 32 or the first terminal apparatus 31. The server controller 12 may calculate the passenger fare and the operation remuneration in advance, before the third user 53 boards the vehicle 20, based on the desired boarding conditions of the third user 53. The server controller 12 may calculate the passenger fare and the operation remuneration after confirming with the vehicle 20 in step S35 that the third user 53 has boarded the vehicle 20. After execution of the procedure in step S36, the server controller 12 ends execution of the procedures of the flowchart in FIG. 7.

In the procedure of step S35, the server controller 12 may receive information, from the third terminal apparatus 33, indicating that the third user 53 has boarded the vehicle 20 designated as the desired boarding vehicle. In this case, the third user 53 may provide input to the third terminal apparatus 33 indicating that the third user 53 boarded the vehicle 20.

In the procedure of step S35, the server controller 12 may receive positional information for the terminal apparatus from the third terminal apparatus 33 and from the second terminal apparatus 32 or the first terminal apparatus 31 and may judge that the third user 53 has boarded the vehicle 20 based on the positional information. For example, when the position of the third terminal apparatus 33 and the position of the second terminal apparatus 32 or the first terminal apparatus 31 move along the same path for a predetermined time, the server controller 12 may judge that the third user 53 is onboard the vehicle 20.

(Summary of Information Processing Methods)

A management intermediary service is provided according to an information processing method of the present embodiment, as described above. In this way, when the first user 51 rides into the first area 61 with the vehicle 20, the first user 51 does not need to park the vehicle 20 in a parking space in order to leave the vehicle 20. Furthermore, the vehicle 20 is managed by the second user 52 who acts as a manager while the first user 51 is away from the vehicle 20. Consequently, the first user 51 can obtain a sense of security about the management status of the vehicle 20, and convenience for the first user 51 is improved.

An on-demand bus service, using the vehicle 20 of which management is entrusted, is provided according to an information processing method of the present embodiment. In this way, the vehicle 20 can be effectively utilized. The first user 51 therefore benefits. Increasing the number of operation vehicles in the on-demand bus service also makes it easier for the third user 53 to board an operation vehicle. Convenience is therefore improved for the third user 53.

### Other Embodiments

### <Change in First Period>

In the management intermediary service, the first period corresponds to the period during which the first user 51 entrusts management of the vehicle 20. In other words, at the end of the first period, entrustment of management of the vehicle 20 ends. In this case, the first user 51 needs to take back the vehicle 20 at the end of the first period. This is because a delay in the first user 51 taking back the vehicle 20 would constrain the second user 52 beyond the time of the entrustment contract, and a parking space for the vehicle 20 might become necessary.

The server controller 12 of the server 10 that provides the management intermediary service may change the first period based on the time at which the first user 51 takes back the vehicle 20. The server controller 12 may apply a penalty to the first user 51 when the first period is extended. The penalty may include an increase in the usage fee or may include restrictions on requests by the first user 51.

On the other hand, when the first user 51 takes back the vehicle 20 by the end of the first period that is determined based on the entrustment request information, the server controller 12 may provide an incentive to the first user. The incentive may include a reduction in the usage fee or may include preferential acceptance of requests by the first user 51.

The server controller 12 may receive the boarding request information on the third user 53 from the third terminal apparatus 33 and accept a boarding reservation prior to receiving the entrustment request information on the vehicle 20 from the first terminal apparatus 31. The server controller 12 generates an operation schedule of the vehicle 20 based on the boarding reservation received from the third user 53. When receiving a request from the first user 51 to entrust management of the vehicle 20, the server controller 12 may preferentially accept entrustment of management of a vehicle 20 that can be operated in accordance with the operation schedule generated based on the boarding reservation of the third user 53.

The server controller 12 may accept entrustment of management of the vehicle 20 on the condition that the first period is changed in accordance with the operation schedule generated based on the boarding reservation of the third user 53. The server controller 12 may provide an incentive to the first user 51 when the first user 51 agrees to change the first period, which was set in the entrustment request information, in accordance with the operation schedule.

User convenience can be increased by implementation of a change in the first period and an incentive or penalty associated with the change. For example, the first user 51 is less susceptible to restrictions on behavior when moving away from the vehicle 20. The third user 53 can easily find an operation vehicle to board.

<Method of Handing Over Vehicle 20>

The vehicle 20 may be handed over when the first user 51 and the second user 52 meet. In this case, a physical key of the vehicle 20 may be passed between the first user 51 and the second user 52. The vehicle 20 may also be handed over without direct contact between the first user 51 and the second user 52. In this case, a physical key of the vehicle 20 may be passed between the first user 51 and the second user 52 using a means such as a locker.

The vehicle 20 may be configured so that locking is controlled, and a power source such as an engine or motor is activated, by a virtual key based on radio waves, as described above. The first user 51 may exit the vehicle 20 in the first area 61, lock the vehicle 20, and move away from the vehicle 20. The server 10 may transmit information about the radio waves corresponding to the virtual key of the vehicle 20 to the second terminal apparatus 32. The second user 52 may unlock the vehicle 20 or drive the vehicle 20 by causing the second terminal apparatus 32 to transmit radio waves corresponding to the virtual key of the vehicle 20. In other words, the second user 52 can use the second terminal apparatus 32 as a virtual key of the vehicle 20. In this way, there is no need to pass a physical key when the vehicle 20 is handed over without direct contact between the first user 51 and the second user 52. The vehicle 20 can therefore be handed over easily, improving convenience for the user.

While an embodiment of the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined together or divided.

1. An information processing apparatus comprising:
a communication interface configured to receive, from a first terminal apparatus of a first user who entrusts management of a vehicle ridden into a predetermined area, entrustment request information including information that specifies the predetermined area; and
a controller configured to determine a second user to assume management of the vehicle based on the entrustment request information and output information to a second terminal apparatus of the second user.

2. The information processing apparatus of claim 1, wherein
the communication interface is configured to receive, from the second terminal apparatus, assumption request information including information specifying an area where the second user can assume management of the vehicle, and
the controller is configured to determine whether to cause the second user to assume management of the vehicle based further on the assumption request information.

3. The information processing apparatus of claim 2, wherein
the entrustment request information further includes information specifying a period during which the first user entrusts management of the vehicle, and
the assumption request information further includes information specifying a period during which the second user can assume management of the vehicle.

4. The information processing apparatus of claim 1, wherein
the communication interface is configured to transmit information on the second user to the first terminal apparatus, and
the controller is configured to determine to cause the second user to assume management of the vehicle when the communication interface receives, from the first terminal apparatus, information indicating that the first user has determined to entrust management of the vehicle to the second user.

5. The information processing apparatus of claim 1, wherein
the controller is configured to calculate a usage fee to be charged to the first user and an assumption remuneration to be paid to the second user, and
the communication interface is configured to transmit information related to the usage fee to the first terminal apparatus and transmit information related to the assumption remuneration to the second terminal apparatus.

6. The information processing apparatus of claim 5, wherein the controller is configured to designate at least a portion of the usage fee as the assumption remuneration.

7. The information processing apparatus of claim 1, wherein
the communication interface is configured to receive boarding request information from a third terminal apparatus of a third user wishing to board the vehicle, and
the controller is configured to determine whether to cause the third user to board the vehicle based on the boarding request information and output information to the third terminal apparatus.

8. The information processing apparatus of claim 7, wherein
the controller is configured to calculate a passenger fare to be charged to the third user and an operation remuneration to be paid to the second user, and
the communication interface is configured to transmit information related to the passenger fare to the third terminal apparatus and transmit information related to the operation remuneration to the first terminal apparatus or the second terminal apparatus.

9. The information processing apparatus of claim 8, wherein the controller is configured to designate at least a portion of the passenger fare as the operation remuneration.

10. The information processing apparatus of claim 8, wherein the controller is configured to distribute at least a portion of the passenger fare to the first user.

11. The information processing apparatus of claim 10, wherein the controller is configured to determine a percentage of the passenger fare to distribute to the first user based on a distance or a time that the vehicle travels while the second user is assuming management of the vehicle.

12. An information processing system comprising the information processing apparatus of claim 1, the first terminal apparatus, and the second terminal apparatus.

13. An information processing method comprising:
receiving, by an information processing apparatus, from a first terminal apparatus of a first user who entrusts management of a vehicle ridden into a predetermined area, entrustment request information including information that specifies the predetermined area; and
determining, by the information processing apparatus, a second user to assume management of the vehicle based on the entrustment request information and outputting information to a second terminal apparatus of the second user.

14. The information processing method of claim 13, further comprising:
receiving, by the information processing apparatus from the second terminal apparatus, assumption request information including information specifying an area where the second user can assume management of the vehicle; and
determining, by the information processing apparatus, whether to cause the second user to assume management of the vehicle based further on the assumption request information.

15. The information processing method of claim 14, wherein
the entrustment request information further includes information specifying a period during which the first user entrusts management of the vehicle, and
the assumption request information further includes information specifying a period during which the second user can assume management of the vehicle.

16. The information processing method of claim 13, further comprising:
transmitting, by the information processing apparatus, information on the second user to the first terminal apparatus; and
determining, by the information processing apparatus, to cause the second user to assume management of the vehicle when information indicating that the first user has determined to entrust management of the vehicle to the second user is received from the first terminal apparatus.

17. The information processing method of claim 13, further comprising:
calculating, by the information processing apparatus, a usage fee to be charged to the first user and an assumption remuneration to be paid to the second user; and
transmitting, by the information processing apparatus, information related to the usage fee to the first terminal apparatus and transmitting information related to the assumption remuneration to the second terminal apparatus.

18. The information processing method of claim 13, further comprising:
receiving, by the information processing apparatus, boarding request information from a third terminal apparatus of a third user wishing to board the vehicle; and
determining, by the information processing apparatus, whether to cause the third user to board the vehicle based on the boarding request information and outputting information to the third terminal apparatus.

19. A terminal apparatus for a user who assumes management of vehicles ridden into a predetermined area, the terminal apparatus comprising:
a communication interface configured to transmit assumption request information including information that specifies the predetermined area and receive information on a vehicle determined based on the assumption request information; and
a controller configured to output the information on the vehicle to the user.

20. The terminal apparatus of claim 19, wherein when the user assumes management of the vehicle, the communication interface is configured to transmit radio waves that correspond to a virtual key of the vehicle.
